(19) United States
(12) Patent Application Publication
(10) Pub. No.: US 2014/0048290 A1
(43) Pub. Date: Feb. 20, 2014

(54) Deoxygenated Water Fill for Fire Protection System

(71) Applicant: Timothy S. Bodemann, Raleigh, NC (US)

(72) Inventor: Timothy S. Bodemann, Raleigh, NC (US)

(73) Assignee: South-Tek Systems, LLC, Raleigh, NC (US)

(21) Appl. No.: 13/589,542

(22) Filed: Aug. 20, 2012

(51) Int. Cl. A62C 35/60; A62C 35/68

(52) U.S. Cl. 169/16; 137/15.04

(57) ABSTRACT

To prevent corrosion, the pipes of a wet fire protection system (FPS) are purged of atmospheric oxygen by displacing in the pipes with an inert gas, such as nitrogen, prior to filling the pipes with water. After oxygen is purged from the pipes, they are filled with deoxygenated water which contains an O2 concentration of 500 ppb or less. The lack of dissolved oxygen in the deoxygenated water prevents O2 molecules from outgassing from the water into spaces within the pipe containing N2 gas. The dearth of oxygen in the system provides long-term corrosion inhibition. Oxygen may be purged from water by exposing the water to an inert gas (such as N2) having a sufficiently low O2 concentration.

### FIELD OF INVENTION

The present invention relates generally to wet fire protection systems, and in particular to a system and method of charging such systems with deoxygenated water.

### BACKGROUND

Fire sprinkler systems are a well-known type of active fire suppression system. Sprinklers are installed in all types of buildings, commercial and residential, and are generally required by fire and building codes for buildings open to the public. Typical sprinkler systems comprise a network of pipes, usually located at ceiling level, that are connected to a reliable water source. Automatically actuated valves called sprinkler heads are disposed along the pipes at regular intervals. Each sprinkler head is operative to open automatically in the event of a fire. For example, one design of sprinkler head includes a fusible element, or a frangible glass bulb, that is heat-sensitive and designed to fail at a predetermined temperature. Failure of the fusible element or glass bulb opens the valve, allowing water to flow through the head, where it is directed by a deflector into a predetermined spray pattern. Sprinkler systems may suppress a fire, or inhibit its growth, thereby saving lives and limiting inventory loss and structural damage. Sprinkler specifications are published by the National Fire Protection Association (e.g., NFPA 13, 13D, 13R).

The sprinkler system (more generally, Fire Protection System, or FPS) is fed from a pump room or riser room. In a large building the FPS consist of several “zones,” each being fed from a riser in the pump room. The riser contains a main isolation valve and other monitoring equipment (e.g., flow switches, alarm sensors, and the like). The riser is typically a 6 or 8 inch diameter pipe coupled through a booster pump (called the fire pump) to the main water supply to the building. The riser then progressively branches off into smaller “cross mains” and branch lines, also known as “zones”. At the furthest point from the riser, typically at the end of each zone, there is an “inspector's test port,” which is used for flow testing. Numerous other valves, such as for filling and/or purging the pipes, testing internal pressure, measuring gas or water properties, and the like, may be included in the FPS pipes.

FPS may be of the “wet” or “dry” types. In a “wet” system the sprinkler pipes in each room are full of water under a predetermined “internal set point” pressure. If the water pressure decreases below the set point, valves are opened and/or a pump is activated, and water flows into the sprinkler pipes in an attempt to maintain the pressure. The set point pressure drops when water escapes the system, such as due to the opening of a sprinkler head in a fire.

To prevent damage to equipment or merchandise by water leaking from the FPS in conditions other than a fire, and in environment conditions in which water in the pipes may freeze, “dry” system are used. A dry FPS uses compressed air in the piping as a “supervisory gas.” The air is maintained at a supervisory pressure, e.g., typically ranging between 13-40 PSI. When a sprinkler head opens, the air pressure drops to atmospheric (e.g., 0 PSI), and a valve opens in response to the lower pressure. The valve locks in the open position and water rushes into the system. One type of dry FPS, known as a pre-action provides increased protection against water damage by increasing the probability that the system is only activated by an actual fire. A pre-action FPS requires one (e.g., Single Interlock) or more (e.g., Double Interlock) action signals before water is injected into the system—for example, both a drop in supervisory air pressure and a signal from a heat or smoke detector.

Building codes specify a minimum angle, measured from the horizontal, at which wet FPS pipe is to be hung. The purpose of this angle is to ensure that water flows to the end of the pipe, so that the internal volume of the pipe is full of water along its entire length, minimizing the delay in water discharge when a sprinkler head opens. Also, codes specify that air vents can be installed at the far end of each pipe from the street valve, to purge air from the pipe interior as the system is “charged” (i.e., when water is initially introduced). However, in practice, there are usually one or more “high” or elevated points in the SDS wet pipe system where air is trapped. This air includes oxygen (O2), which reacts with the water and pipe steel to cause corrosion, which may be either galvanic or organic origin. Sometimes, microbes can grow in the water and accelerate the corrosion by means of the byproducts that they produce during their metabolic cycle. This is called Microbiologically Influenced Corrosion (MIC). Over time, MIC or galvanic corrosion can cause extensive damage to a wet FPS, eventually resulting in leaks. Both the damage caused by leaking water, and the need to replace corroded FPS pipes, provide significant incentive to minimize or eliminate wet FPS corrosion due to O2 within the pipes.

One approach to solving this problem is to purge atmospheric air from the FPS pipes using an inert gas, such as nitrogen (N2), prior to charging the system. Nitrogen is an inert gas, and pure N2 contains no oxygen. However, commercially common means of generating N2, such as by membrane-filtering atmospheric air, generate N2 in the range of 95%-98% purity and Pressure Swing Adsorption systems generate N2 in the range of 95%-99.999% purity; accordingly, this N2 may contain some concentration of O2. Additionally, nitrogen has a dew point of −40° F., meaning it can absorb water vapor (as well as other gases dissolved in the water) at any higher temperature.

Water usually contains dissolved oxygen—that is, O2 molecules, apart from the oxygen bound up in the H2O molecules forming the water itself. As one example, a test of local city water at 60 degrees F. in Charlotte, N.C. revealed an O2 content of 9.617 ppm (parts per million). Due to the partial pressure of gases, O2 from such water will outgas into the pockets containing N2, providing enough O2 for the onset of detrimental corrosion. Accordingly, simply purging wet FPS pipes with N2 prior to charging the system is not a long-term solution to corrosion.

The Background section of this document is provided to place embodiments of the present invention in technological and operational context, to assist those of skill in the art in understanding their scope and utility. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure is not intended to identify key/critical elements of embodiments of the invention or delineate the scope of the invention. The sole purpose of this summary is to present some concepts disclosed herein in a simplified form as a prelude to the more detailed description that is presented later.

According to one or more embodiments described and claimed herein, in addition to purging wet FPS pipes of O2 prior to charging, the pipes are filled with water that has been sufficiently deoxygenated that little or no O2 is available to outgas into N2-filled spaces. Oxygen may be purged from water by exposing it to an inert gas (such as N2) having a sufficiently low O2 concentration.

One embodiment relates to a method of suppressing corrosion in a wet FPS including at least one pipe, each pipe including a plurality of automatically activated valves operative to open and discharge water in the event of a fire, the system further including at least fill and purge valves located at spaced-apart distances in one or more pipes. Atmospheric oxygen is purged from the pipes by injecting an inert gas into at least one fill valve, and oxygen displaced by the inert gas is discharged via at least one purge valve. After purging O2 from the pipes, the pipes are filled with deoxygenated water having an O2 concentration of 500 ppb (parts per billion) or less.

Another embodiment relates to a corrosion resistant wet fire protection system. The system includes at least one pipe, and each pipe includes a plurality of automatically activated valves operative to open and discharge water in the event of a fire. At least one fill and one purge valve are disposed in one or more pipes, and the fill and purge valves are located at spaced-apart distances. The pipes are filled with deoxygenated water having an O2 concentration of 500 ppb or less. Any internal volume of the pipes not filled with deoxygenated water contains an inert gas. The internal volume of the pipes is substantially devoid of O2, thus prohibiting corrosion.

### BRIEF DESCRIPTION OF THE DRAWINGS

FIG. 1 is a functional block diagram of a corrosion-inhibiting wet Fire Protection System.

FIG. 2 is a flow diagram of a method of suppressing corrosion in a wet Fire Protection System.

### DETAILED DESCRIPTION

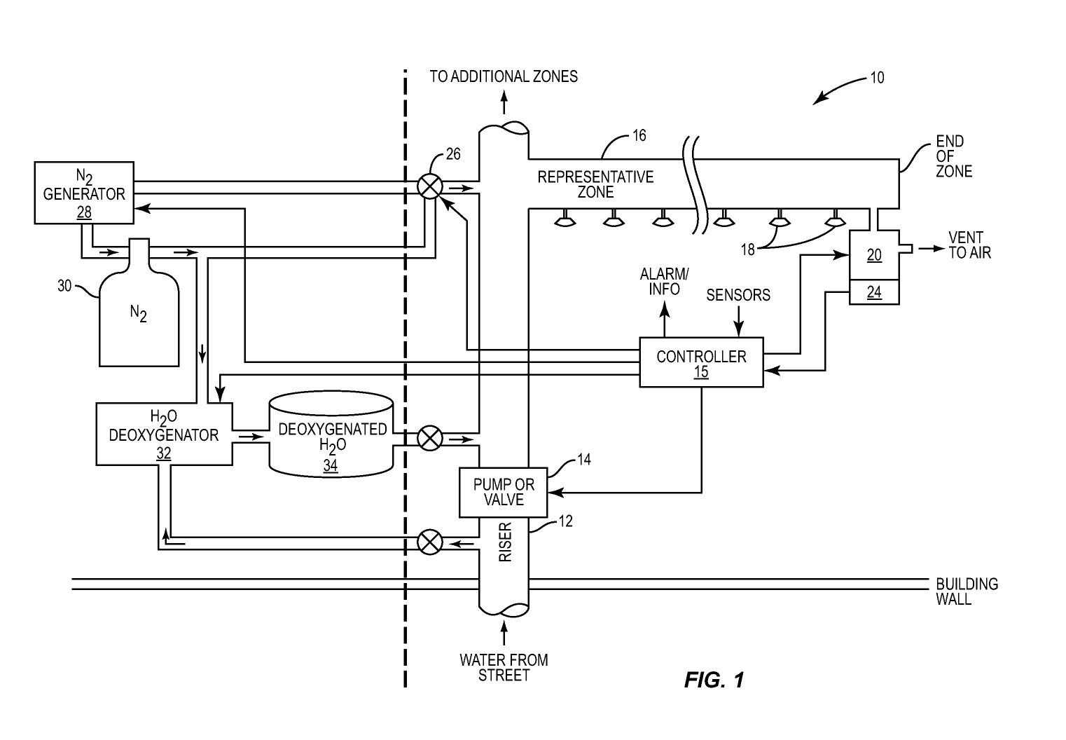

FIG. 1 depicts, in functional schematic form, a corrosion-inhibiting wet Fire Protection System (FPS) 10, according to a representative embodiment of the present invention, which inhibits Microbiologically Influenced Corrosion (MIC) and/or galvanic corrosion and thus prevents or minimizes corrosion-induced leaks to the system. Once configured and charged, the corrosion-inhibiting wet FPS 10 operates similarly to a conventional wet FPS; the corrosion-inhibiting wet FPS 10 differs in its initialization and charging. In particular, air in the corrosion-inhibiting wet FPS 10 piping is purged of atmospheric oxygen (O2) prior to charging by displacing it with an inert gas, and the system 10 is charged with deoxygenated water. This combination virtually eliminates O2 from the interior volume of the corrosion-inhibiting wet FPS 10 piping, thus inhibiting or eliminating corrosion over extended durations by suppressing oxidation. In a presently preferred embodiment, the inert gas is nitrogen (N₂), due to the ease and low cost of extracting high-purity nitrogen from ambient air. However, any non-reactive gas, such as helium, neon, argon, or the like, may be utilized within the scope of the present invention.

The corrosion-resistant wet FPS 10 includes all of the functions and features of a conventional wet FPS. Indeed, most of the elements depicted in FIG. 1 to the right of the dashed vertical line are present in a conventional wet FPS. These include a riser 12 connected to a reliable source of water, such as local city water as it enters the building. A pump or valve 14 isolates the riser 12 from one or more FPS zones 16. Although depicted schematically as a single pipe, an FPS zone 16 may comprise a small network of pipes, such as required to cover a floor of a building, a particular portion of a floor, or the like. Disposed at regular intervals along each zone 16 pipe is a plurality of sprinkler heads 18. As discussed above, a sprinkler head 18 is a normally-closed valve that is automatically actuated in the event of a fire, to release water from the FPS 10 for fire suppression.

At the end of each zone 16 at least one purge valve 20 may be opened to vent atmospheric air from the interior of the zone 16 pipes. In one embodiment, the purge valve 20 is actuated under the control of a controller 22, via a wired or wireless connection. In other embodiments, the purge valve is 20 may be manually actuated. In one embodiment, an O2 sensor 24 may additionally be disposed at the end of each FPS zone 16. The O2 sensor 24 is operative to detect and quantify the concentration of O2 in air or gas being vented by the purge valve 20. In one embodiment, the O2 sensor 24 is operative to communicate sensed O2 concentration to the controller 22, via a wired or wireless connection. In other embodiments, the O2 sensor 24 includes a gauge or other display that is read manually.

The controller 22 may additionally receive input from one or more sensors (not depicted). For example, a pressure sensor disposed in the zone 16 piping may detect a drop in water pressure, indicating that a sprinkler head 18 has opened, triggering the controller 22 to activated or open the pump or valve 14, respectively. Additionally, the controller 22 may receive inputs from smoke detectors, heat sensors, and the like. The controller 22 may additionally generate outputs, such as an alarm indication if a fire is detected, routine status and operating parameter outputs, and the like. In particular, the controller 22 may communicate with, or may indeed form a part of, a building-wide automated maintenance system, that includes and controls fire detection and suppression, access and security functions, HVAC, lighting, and the like.

According to embodiments of the present invention, the corrosion-inhibiting wet FPS 10 of the present invention is initialized and charged in a way that virtually eliminates O2 from the interior volume of FPS 10 pipes. To this end, at least some of the elements depicted in FIG. 1 to the left of the vertical line are present at least during the initialization and charging of the corrosion-inhibiting wet FPS 10, and in some embodiments, some or all of these elements may be permanently installed.

Prior to charging the corrosion-inhibiting wet FPS 10, atmospheric air is purged from the zone 16 piping by displacing it with an inert gas, such as nitrogen (N2). To facilitate this, a N2 generator 28 may be provided and selectively coupled to the FPS 10 pipes via a normally-closed fill valve 26. In a permanent installation, the N2 generator and fill valve 26 may be controlled by the controller 22, via a wired or wireless connection. A suitable N2 generator 28 is the MICBlast™ FPS Nitrogen Generator, available from South-Tek Systems of Wilmington, N.C. In one embodiment, the N2 generator 28 preferably generates N2 of 95% or greater purity. In one embodiment, the N2 generator 28 preferably generates N2 of 98% or greater purity. In one embodiment, the N2 generator 28 preferably generates N2 of 99.9% or greater purity.

Reserve nitrogen may be generated and stored in a tank 30. In one embodiment, for example in a small building with only one or a few zones 16, a N2 generator 26 may not be required, and sufficient N2 may be supplied by a portable tank 28 provided on-site only for the initialization of the FPS 10. In this case, the N2 generator 28 is located off-site.

In either case, prior to charging the corrosion-inhibiting wet FPS 10 by introducing water into the zone 16 piping, atmospheric air (which includes approximately 20.8% O2 by volume) is purged from the zone 16 piping. To accomplish this, both the purge valve 20 and fill valve 26 are opened, and either the N2 generator is actuated or the N2 tank 28 is opened. The gas purged from the zone 16 piping is monitored by the O2 sensor 24. When the gas escaping from the purge valve 20 is sufficiently oxygen-free (e.g., when the N2 has displaced all atmospheric air in the pipes), the purge valve 20 and fill valve 26 are closed.

After O2 has been purged from the zone 16 piping, and the corrosion-inhibiting wet FPS 10 is charged with deoxygenated water. Typically, water contains approximately 10 to 14 ppm (parts per million) O2 near freezing, decreasing to about 6 to 10 ppm O2 at 45° C. Water is considered to be hypoxic when it contains less than 0.2 ppm O2. Water completely devoid of O2 is called anoxic. As used herein, the term “deoxygenated water” includes both hypoxic and anoxic water. In particular, as used herein, the term “deoxygenated water” for corrosion inhibiting purposes means water with an O2 concentration of 500 ppb (parts per billion) or less. The O2 concentration of water will vary with temperature. In one embodiment, the oxygenated water preferably has an O2 concentration of 300 ppb or less. In one embodiment, the oxygenated water preferably has an O2 concentration of 150 ppb or less.

Water may be deoxygenated by exposure to low-O2-concentration gas and/or vacuum conditions to draw O2 and other residual free gasses out of the water, causing the dissolved O2 to “outgas” into the lower-concentration gas or vacuum. For example, one suitable deoxygenation system is the Membrana Liqui-Cell® “Membrane Contactor,” available from Membrana Filtration of Charlotte, N.C. This device has a water inlet and outlet. The Contactor is filled with a gas separation media. Water from the street enters into the Contactor (Water IN). Within the body of the contractor is a gas inlet for introducing high purity nitrogen (N2 gas IN) and an outlet to which a gas vacuum is pulled (O2 gas OUT). As the water enters the Contactor, the nitrogen gas is allowed to permeate the Contactor media through the N2 gas inlet, displacing the free O2 molecules which are vacuum swept out of the water. This reduces the concentration of free O2 within the water that leaves the Contactor (O2 Depleted Water OUT).

In one embodiment, again contemplated for a large installation, the corrosion-inhibiting wet FPS 10 includes a water deoxygenator 32, which may be operated either manually, or under the control of the controller 22 via a wired or wireless connection. In the embodiment depicted in FIG. 1, the water deoxygenator 32 operates using N2 supplied by the N2 generator 28 or N2 tank 30. A suitable water deoxygenator 32 is the Membrana Liqui-cell® system described above. Deoxygenated water is stored in a tank 34 selectively coupled to the FPS 10 piping downstream of the main pump or valve 14. In another embodiment, suitable for smaller installations, the deoxygenated water tank 34 may be portable and provided on-site only for FPS 10 charging, with the water deoxygenator 32 located off-site. This embodiment is also advantageous for use at multiple sites when water is first introduced into the wet FPS 10 or when water is drained for testing or repair, and the wet FPS 10 must be refilled with deoxygenated water.

In either case, after atmospheric air is purged from the FPS 10 piping by being displaced by, e.g., N2 gas, each zone 16 is charged by opening the purge valve 20 to release the N2, and filing the pipes with deoxygenated water from the tank 34 (e.g., via a pump, not depicted in FIG. 1 for clarity). Ideally, the deoxygenated water should fully fill the interior volume of all zone 16 pipes. However, in practice, there will be at least some voids in which N2 gas remains. However, because the charging water has been deoxygenated, there is essentially no dissolved oxygen to offgas into the N2-filled spaces, and hence no free oxygen is available for the oxidation processes that cause corrosion, or to support microorganisms involved in MIC. Furthermore, absent some significant leak in the system, there is no mechanism for O2 to enter the pipes; hence, embodiments of the present invention provide a long-term corrosion-inhibiting solution.

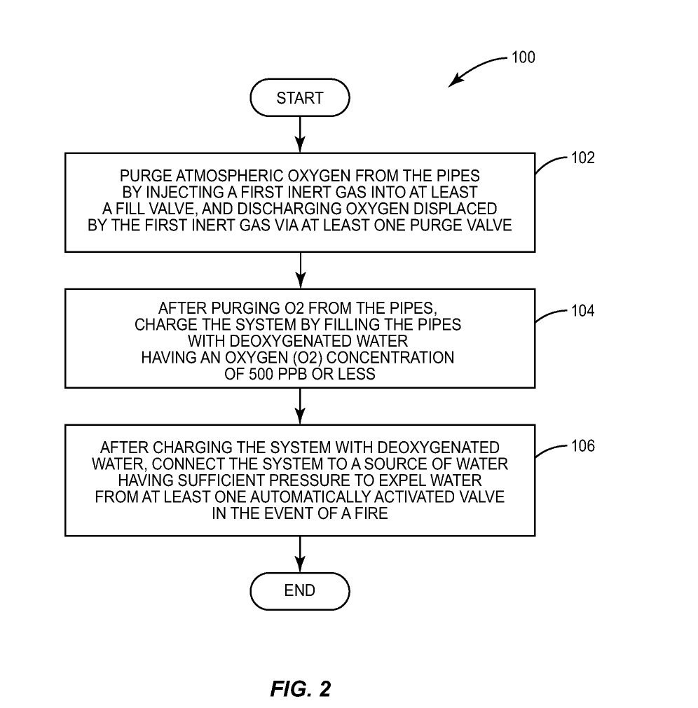

FIG. 2 depicts a flow diagram of the steps of a method 100 of suppressing corrosion in a wet FPS 10. The corrosion-inhibiting wet FPS 10 includes at least one pipe, and each pipe includes a plurality of automatically activated valves 18 operative to open and discharge water in the event of a fire. The corrosion-inhibiting wet FPS 10 further includes at least a fill valve 26 and a purge valve 20 located at spaced-apart distances in one or more pipes. The method begins by purging atmospheric oxygen from the pipes by injecting an inert gas into at least the fill valve 26, and discharging oxygen displaced by the inert gas via at least the purge valve 20 (block 102). After purging O2 from the pipes, the method continues by filling the pipes with deoxygenated water having an O2 concentration of 500 ppm or less (block 104). In particular, this method steps may comprise opening the purge valve 20 to allow the inert gas to escape while pumping deoxygenated water into the zone 16 from a deoxygenated water tank 34, and then closing the purge valve 20. Finally, after filling the pipes with deoxygenated water, the method continues by connecting the zone 16 pipes to a source of water (e.g., via pump or valve 14) having sufficient pressure to expel water from at least one automatically activated valve 20 in the event of a fire. Although the non-deoxygenated water includes dissolved oxygen, all of the FPS 10 pipes downstream of the main pump or valve 14 are full of deoxygenated water, and little of the non-deoxygenated water will mix therewith. In particular, no non-deoxygenated water will migrate to the near-horizontal zone 16 pipes, in which corrosion is a concern.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of suppressing corrosion in a wet fire protection system including at least one pipe, each pipe including a plurality of automatically activated valves operative to open and discharge water in the event of a fire, the system further including at least fill and purge valves located at spaced-apart distances in one or more pipes, the method comprising:
purging atmospheric oxygen from the pipes by injecting a first inert gas into at least a fill valve, and discharging oxygen displaced by the first inert gas via at least one purge valve; and
after purging O2 from the pipes, filling the pipes with deoxygenated water having an oxygen (O2) concentration of 500 ppb (parts per billion) or less.

2. The method of claim 1 wherein the first inert gas comprises nitrogen (N2).

3. The method of claim 2 wherein the first inert gas is at least 95% pure N2.

4. The method of claim 2 wherein the first inert gas is at least 98% pure N2.

5. The method of claim 1 wherein the deoxygenated water has an O2 concentration of less than 300 ppb.

6. The method of claim 1 wherein the deoxygenated water has an O2 concentration of less than 150 ppb.

7. The method of claim 1 further comprising:
deoxygenating water by exposing the water to a second inert gas having an O2 concentration of 500 ppb or less, and removing the second inert gas with a vacuum.

8. The method of claim 7 wherein the second inert gas comprises nitrogen.

9. The method of claim 1 further comprising:
after filling the pipes with deoxygenated water, connecting the pipes to a source of water having sufficient pressure to expel water from at least one automatically activated valve in the event of a fire.

10. A corrosion-inhibiting wet fire protection system, comprising:
at least one pipe, each pipe including a plurality of automatically activated valves operative to open and discharge water in the event of a fire;
at least one fill and one purge valve in one or more pipes, the fill and purge valves located at spaced-apart distances;
deoxygenated water having an oxygen (O2) concentration of 500 ppb (parts per billion) or less filling the pipes; and
any internal volume of the pipes not filled with deoxygenated water, containing an inert gas;
whereby the internal volume of the pipes is substantially devoid of O2, thus prohibiting corrosion.

11. The system of claim 10, further comprising a source of water connected to the pipes, the water at a pressure sufficient to expel water from at least one automatically activated valve in the event of a fire.
